(19) United States
(12) Patent Application Publication
(10) Pub. No.: US 2025/0108970 A1
(43) Pub. Date: Apr. 3, 2025

(54) PUMPING TUMBLER FOR PREPARING BEVERAGE AND ADDITIVE CAPSULE THEREFOR

(71) Applicant: Moon Sik PARK, Incheon (KR)

(72) Inventor: Moon Sik PARK, Incheon (KR)

(21) Appl. No.: 18/981,493

(22) Filed: Dec. 14, 2024

Related U.S. Application Data
(62) Division of application No. 18/981,455, filed on Dec. 14, 2024.
Application No. 18/981,455 is a continuation of application No. PCT/KR2023/008332, filed on Jun. 15, 2023.

(30) Foreign Application Priority Data
Jun. 15, 2022 (KR) 10-2022-0073163
Jun. 15, 2022 (KR) 10-2022-0073164
Jun. 15, 2022 (KR) 10-2022-0073165
Jun. 15, 2022 (KR) 10-2022-0073166
Jun. 15, 2023 (KR) 10-2023-0077087
Jun. 15, 2023 (KR) 10-2023-0077088
Jun. 15, 2023 (KR) 10-2023-0077089
Jun. 15, 2023 (KR) 10-2023-0077090

(51) Int. Cl. B65D 81/32; B65D 47/06

(52) U.S. Cl. CPC B65D 81/3222; B65D 47/06; B65D 81/325

(57) ABSTRACT

Provided is a portable pumping tumbler for preparing a beverage, having both drinking water and an additive received therein, thereby enabling the additive to be pumped and added into the drinking water according to the needs of a user and enabling a beverage to be easily prepared, comprising: a drinking water tray having an opened upper part and a shielded lower end to have formed therein a drinking water storage space; a cover unit detachably coupled to the upper part of the drinking water tray to shield the upper part of the drinking water tray, and having a drinking opening formed; an additive tray detachably coupled to the lower end of the drinking water tray and has formed therein an additive storage space; and a pumping unit installed inside the drinking water tray and the cover unit.

### TECHNICAL FIELD

The present invention relates to a pumping tumbler for preparing beverages, and more particularly to a pumping tumbler for preparing beverages which is capable of facilitating the preparation of a beverage by receiving drinking water and an additive together and pumping the additive according to a user's need so as to be added to the drinking water, which is easy to use, which is capable of preventing leakage of contents that may occur during use, and the interior of which can be easily cleaned, whereby usability and hygiene of the pumping tumbler are improved.

### BACKGROUND ART

In recent years, due to the development of the culture of carrying and drinking beverages and the change in environmental awareness due to the controversy over the harmfulness of disposable cups, the number of users who use personal tumblers to carry and drink beverages is greatly increasing.

Such a personal tumbler generally includes a cylindrical container body and a lid configured to open and close an upper end of the container body, wherein a beverage is stored in the container body, and the lid is opened to drink the beverage.

Meanwhile, the number of users of such tumblers, especially the number of athletes, fitness trainers, bodybuilders, and the like, who mix beverages such as milk with water, has increased, and various products have been developed accordingly.

Accordingly, as an example of the tumbler described above, Korean Patent Application Publication No. 10-2019-0066803 discloses a tumbler for infants having a holder case, the holder case including a main body portion having a space in which liquid is received, the main body portion including a container and a cap coupled to the container, an upper lid rotatably coupled to the main body portion, a protective cover into which the main body portion is inserted, and a holder strap rotatably installed on the protective cover, wherein both ends of the holder strap in a longitudinal direction are rotatably supported by the protective cover, and a seating recess into which the holder strap is inserted is formed in a side of the cap.

However, since the conventional tumbler described above has a structure in which the lid is opened and closed by rotating one side of the main body portion, there is a problem that the lid is easily opened by unintended external force or the like when carrying, which causes problems in terms of usability and hygiene.

### DISCLOSURE

### Technical Problem

The present invention has been made in view of the above conventional problems, and it is an object of the present invention to provide a pumping tumbler for preparing beverages configured such that a lid portion has a horizontal rotary type structure, whereby it is easy to use the lid portion and the lid portion is prevented from being opened by unintended external force or the like when carrying, and therefore it is possible to prevent a hygienic problem due to leakage of contents.

It is another object of the present invention to provide a pumping tumbler for preparing beverages configured such that drinking water and a liquid additive are stored in the tumbler without the need to separately store the additive and separately withdraw the same, whereby usability and hygiene are improved, a certain amount of additive is added through a pumping unit mounted in the tumbler, whereby a beverage is easily prepared, and internal negative pressure that may occur during pumping is removed in order to smoothly perform pumping, whereby the amount of additive discharged is kept constant.

It is a further object of the present invention to provide a pumping tumbler for preparing beverages configured such that the interior of a pumping portion is easily disassembled to facilitate internal cleaning, whereby hygiene is improved, unlike conventional pumping tumblers in which it is difficult to clean a flow path in the pumping portion.

### Technical Solution

A pumping tumbler for preparing beverages according to the present invention to accomplish the above objects includes a drinking water tray configured such that an upper part is open, a lower end is shielded, and a drinking water storage space configured to store drinking water or a beverage is formed therein, a cover unit detachably coupled to the upper part of the drinking water tray, the cover unit being configured to shield the open upper part of the drinking water tray, the cover unit being provided with a drinking hole through which a user can drink the drinking water or the beverage in the drinking water storage space, an additive tray detachably coupled to the lower end of the drinking water tray, the additive tray having formed therein an additive storage space configured to store an additive, and a pumping unit installed in the drinking water tray and the cover unit, the pumping unit being configured to pump the additive in the additive tray through a flow path formed through a bottom surface of the drinking water tray and to supply the additive to drinking water storage space.

The cover unit may include a closure portion detachably coupled to the drinking water tray, the drinking hole being formed through an upper surface of the closure portion, the pumping unit being installed through an upper surface of the closer portion so as to be spaced apart from the drinking hole, a rotating lid portion rotatably coupled to an upper part of the closure portion, the rotating lid portion being configured to rotate about a rotating shaft formed therein so as to extend in a downward direction, the rotating lid portion having an opening through which the closure portion is exposed, the drinking hole and an upper part of the pumping unit being exposed through the opening upon rotation, and a shielding support portion located downwardly of the closure portion, the shielding support portion being moved upward and downward in an axial direction of the rotating lid portion by rotation of the rotating lid portion, the shielding support portion being configured to open and close the drinking hole upon rotation of the rotating lid portion.

Depending on relative rotational positions of the closure portion and the rotating lid portion, the cover unit may be operated in any one of a storage mode in which the drinking hole and the pumping unit are shielded to prevent the user from consuming the drinking water or the beverage and to prevent operation of the pumping unit and in which the drinking hole is shielded by the shielding support portion and a use mode in which the drinking hole is opened by the opening to allow the user to consume the drinking water or the beverage through the drinking hole or the pumping unit is opened to allow the user to operate the pumping unit.

The shielding support portion may include a support body rotatably inserted into a rotating shaft extending downward into the rotating lid portion, the support body being interlocked with the rotating shaft so as to be moved upward and downward, a shielding portion configured such that one end is coupled to an outer surface of the support body and the other end formed so as to extend from the one end opens and closes the drinking hole, and an air shielding portion coupled to the outer surface of the support body so as to protrude therefrom, the air shielding portion extending so as to open and close an air hole formed in the closure portion by rotation of the rotating shaft.

When the rotating lid portion is rotated in a direction for the storage mode, the support body may be moved upward, whereby the shielding portion and the air shielding portion may shield the drinking hole and the air hole, respectively, and when the rotating lid portion is rotated in a direction for the use mode, the support body may be moved downward, whereby the shielding portion and the air shielding portion may open the drinking hole and the air hole, respectively.

The shielding support portion may further include a balance support portion coupled to the outer surface of the support body between the shielding portion and the air shielding portion so as to protrude therefrom, the balance support portion being configured to prevent the occurrence of eccentricity between the shielding portion and the air shielding portion around the rotating shaft.

The closure portion may be provided with a guide slit into which a side surface of an upper part of the shielding support portion is fitted, the guide slit being configured to guide upward and downward movement of the shielding support portion, one side of the shielding support portion being inserted into the guide slit such that rotation of the shielding support portion is limited.

A guide recess may be formed in an upper surface of the closure portion of the cover unit, the guide recess having an arc shape corresponding to the radius of rotation of the rotating lid portion, and an anti-rotation stopper protrusion may protrude from a lower surface of the rotating lid portion, the stopper protrusion being fitted into the guide recess, the stopper protrusion being configured to limit a rotation angle of the rotating lid portion.

When the rotating lid portion is rotated in a direction for the use mode, a contact surface of the stopper abutting a side surface of the guide recess may be formed as an inclined surface, and when more than a predetermined level of rotational force is applied to the rotating lid portion in the direction for the use mode, the stopper may be separated from the guide recess and rotated to move the support body downward.

When the rotating lid portion is rotated in the direction for the use mode, a contact surface of the guide recess abutting an outer surface of the stopper may be formed as an inclined surface, and when more than a predetermined level of rotational force is applied to the rotating lid portion in the direction for the use mode, the stopper may be separated from the guide recess and rotated to move the support body downward.

The shielding support portion may further include a lock cover coupled to a lower end of the rotating shaft, the lock cover being configured to limit the downward position of the support body.

The pumping unit may include a pumping button portion installed on the cover unit so as to perform sliding reciprocating movement, the pumping button portion being moved by pressing of the user, and a pumping portion located in the drinking water storage space of the drinking water tray, the pumping portion being moved upward and downward by the reciprocating movement of the pumping button portion, the pumping portion being connected to the drinking water storage space and the additive storage space so as to communicate therewith, the pumping portion being configured to suction the additive and to discharge the additive to the drinking water storage space by upward and downward movement thereof.

The additive may be suctioned through a through-hole formed through a lower end of the pumping portion and a central part of the bottom surface of the drinking water tray so as to communicate therewith and a suction pipe module coupled to an outer surface of the bottom of the drinking water tray, the suction pipe module extending inwardly of the additive tray.

The pumping button portion may include a stem portion slidably installed in an insertion hole of the drinking water tray, an upper part of the stem portion being exposed to the outside of the drinking water tray such that an upper end of the stem portion is pressed by the user, a lower part of the stem portion being configured to transmit external force to the pumping portion, and a guide bushing configured to guide the stem portion inserted thereinto so as to perform reciprocating movement.

The pumping portion may include a piston portion located in the drinking water storage space, the piston portion being connected to the additive tray so as to communicate therewith, the piston portion being configured to suction the additive from the additive tray by reciprocating movement of the pumping button portion, and a discharge pipe extending from an end of the piston portion in a “U” shape, the discharge pipe being formed in a hollow pipe shape, the discharge pipe being configured to discharge the pumped additive to the drinking water storage space, the discharge pipe being interlocked with the pumping button portion, the discharge pipe being moved upward and downward by reciprocating movement of the pumping button portion to press the piston portion.

The discharge pipe may be provided at a “U”-shaped curved surface thereof with an openable closure plate, the closure plate being opened such that the piston portion and an additive flow path of the discharge pipe are easily washed when the pumping portion is washed.

The piston portion may include a piston rod having a flow path formed therein, the piston rod being coupled to the discharge pipe so as to communicate therewith, the piston rod being moved upward and downward by reciprocating movement of the pumping button portion, a piston housing having an inner space in which the piston rod is installed so as to be moved upward and downward, the piston housing being provided in a lower end surface thereof with a through-hole communicating with an interior of the additive tray, the additive being introduced into the inner space by upward and downward movement of the piston rod, and an elastic member coupled to the piston rod, the elastic member being configured to provide resilient force to the piston rod.

The piston rod may be detachably coupled to the piston housing, the piston rod being coupled to the piston housing so as to be separated therefrom upon washing.

The piston rod and the piston housing may be coupled to each other by insertion of a fastening protrusion protruding from a side surface of a fastening ring coupled to the piston rod so as to be movable upward and downward therealong into a fastening recess formed in the piston housing.

The fastening recess may include an upper incision portion formed so as to have a size corresponding to the width of the fastening protrusion such that the fastening protrusion can be inserted from an upper outside, a horizontal slit extending from a lower end of the upper incision portion in a horizontal direction, the horizontal slit being configured to allow the fastening protrusion inserted into the upper incision portion to be moved by rotation, and a vertical seating portion extending upwardly of an end of the horizontal slit such that the fastening protrusion moved along the horizontal slit is moved upward and seated thereon by elastic force of the elastic member, thereby limiting rotational movement.

The suction pipe module may include a coupling plate detachably coupled to the lower end of the drinking water tray, the coupling plate being formed in a disc shape, an expansion plate detachably coupled to the center of a lower part of the coupling plate by screw engagement, the expansion plate being formed in a disc shape, a suction pipe integrally formed at the expansion plate, the suction pipe extending downward from the expansion plate to the additive tray, and an introduction flow path may be formed in the coupling plate, the expansion plate, and the suction pipe, the introduction flow path being configured to allow the coupling plate, the expansion plate, and the suction pipe to communicate with each other therethrough and to allow the additive to move therethrough.

The suction pipe may be formed as a tapered circular pipe having a width gradually decreasing in a downward direction.

The pumping tumbler may further include an elastic cover coupled to an outside of an upper part of the coupling plate, the elastic cover being in tight contact with the lower end of the drinking water tray, the elastic cover being made of an elastic material.

When the additive tray and the drinking water tray are coupled to each other by screw engagement, an outside of the elastic cover may be located between an upper end surface of the additive tray and a lower surface of an outside of the drinking water tray, and the outside of the elastic cover may be pressed by force of coupling between the additive tray and the drinking water tray due to screw engagement, whereby an inner space of the additive tray may be sealed.

A lower surface of the expansion plate may be formed as a protruding curved surface protruding from a central part as a curved surface such that adhesion at a central part of an interface is improved upon pressing.

The pumping tumbler may further include an opening and closing ball valve provided above the introduction flow path of the suction pipe module, the opening and closing ball valve being configured to selectively open and close the introduction flow path according to upward and downward movement of the piston rod.

The additive tray may be open at an upper part thereof and shielded at a lower end thereof such that the additive storage space is formed therein, the additive tray being detachably coupled to a lower part of the drinking water tray.

The additive tray may further include a shielding cover configured to prevent leakage of the additive received in the additive tray, the shielding cover being press-fitted into an upper part of the additive tray, the shielding cover being formed as a disc made of an elastic material, the shielding cover being provided in the center thereof with a central through-hole configured to allow the suction pipe to extend therethrough.

An upper surface of the shielding cover may be formed as a concave surface corresponding in shape to the curved surface of the lower part of the expansion plate.

The shielding cover may be provided on the upper surface thereof with a gripping portion configured to be gripped upon withdrawal of the shielding cover.

An additive capsule configured as a disposable container configured to store an additive may be inserted into the additive tray, wherein the additive capsule may include a container portion abutting an inner surface and a bottom surface of the additive tray and a lid film configured to shield an upper surface of the container portion.

The lid film may be punched by pressing of the suction pipe.

A catching jaw and a catching protrusion may be formed respectively on an outer surface of the container portion and an inner surface of the additive tray at positions corresponding to each other when coupled to each other, and when the additive tray is separated from the drinking water tray, the additive capsule may be located in the additive tray.

A sidewall of the container portion may include a protrusion formed as a result of an upper part of an outer circumferential surface thereof protruding outward, and a stepped portion configured to be seated on the inner surface of the additive tray may be formed at a boundary of the protrusion.

A seating portion configured to be seated on the edge of an upper end of the additive tray may be formed at the edge of an upper end of the sidewall.

The seating portion may include a horizontal plate extending outward in parallel from the upper end of the sidewall by a distance corresponding to the thickness of the edge of the upper end of the additive tray and a vertical plate extending downward from an end of the horizontal plate by a predetermined distance.

The additive tray may further include an additive tray lid portion configured to shield the upper part of the additive tray in order to secure stand-alone portability of the additive tray in the state in which the additive tray is separated from the drinking water tray, and the additive tray lid portion may be formed as a lid coupled to the additive tray by screw engagement, the additive tray lid portion being provided in the center of an inner surface thereof with a pressing protrusion surface configured to shield a through-hole of an upper part of the additive capsule or a through-hole of the shielding cover, the pressing protrusion surface being a hemispherical downwardly protruding curved surface.

In forming a normal pressure flow path configured to introduce outside air into the additive tray in order to maintain normal pressure in the additive tray upon pumping the additive received in the additive tray, the normal pressure flow path may include a first normal pressure flow path configured to allow the outside air to be introduced into a lower space of the drinking water tray therethrough, a second normal pressure flow path communicating with the first normal pressure flow path, the second normal pressure flow path being configured to allow the introduced outside air to be introduced into a space between the elastic cover and the coupling plate therethrough, and a third normal pressure flow path communicating with the second normal pressure flow path, third normal pressure flow path being configured to allow the introduced outside air to move into the inner space of the additive tray under the coupling plate therethrough.

In the first normal pressure flow path, in order to form a space at an outside between the elastic cover and the lower end of the drinking water tray, a part of any one of an upper part of the elastic cover and the lower end of the drinking water tray may be formed as a stepped surface or an inclined surface, and the outside air may be introduced into the space between the elastic cover and the lower end of the drinking water tray through an inlet hole formed in a part of a side surface of the drinking water tray located in the space between the elastic cover and the lower end of the drinking water tray.

In the first normal pressure flow path, in order to form a space at an outside between the elastic cover and the lower end of the drinking water tray, a part of any one of an upper part of the elastic cover and the lower end of the drinking water tray may be formed as a stepped surface or an inclined surface, a part of the interface between an inner surface of the lower part of the drinking water tray and an outer surface of the elastic cover may be provided with a spacing recess through which the introduced outside air can move, and the outside air introduced through a space formed between coupling surfaces and coupling ends of the drinking water tray and the additive tray may be introduced into the space at the outside between the elastic cover and the lower end of the drinking water tray.

The second normal pressure flow path may be formed by a vertical communication hole formed in the elastic cover, the vertical communication hole being configured to allow the space between the elastic cover and the lower end of the drinking water tray and a space between a lower part of the elastic cover and the coupling plate to communicate with each other therethrough.

In the first normal pressure flow path, an outer surface of the elastic cover may be configured such that an upper part of the outer surface of the elastic cover abuts an inner surface of the lower part of the drinking water tray and a lower part of the outer surface of the elastic cover is spaced apart from the inner surface of the lower part of the drinking water tray such that a predetermined space is formed therebetween, and the outside air introduced through a space formed between coupling surfaces and coupling ends of the drinking water tray and the additive tray may be introduced into a space between a lower part of an outer surface of the elastic cover and an inner surface of the lower part of the drinking water tray.

The second normal pressure flow path may be formed by a horizontal communication hole formed in a side surface of the elastic cover, the horizontal communication hole being configured to allow the space between the lower part of the outer surface of the elastic cover and the inner surface the lower part of the drinking water tray and a space between a lower part of the elastic cover and the coupling plate to communicate with each other therethrough.

The space formed between the coupling ends of the drinking water tray and the additive tray may be formed by introduction incision portions formed in the coupling ends of the drinking water tray and the additive tray.

In addition, the space formed between the coupling ends of the drinking water tray and the additive tray may be formed by a step formed at the coupling ends of the drinking water tray and the additive tray.

The coupling step may be formed by the sum of the screw engagement height of the outside of the upper part of the additive tray and the height of the outer surface of the elastic cover minus the screw engagement height of an inside of the lower part of the drinking water tray.

The coupling step may have a size of 1 to 10 mm.

The space formed between the coupling surfaces of the drinking water tray and the additive tray may be formed by a gap between coupling threads of the drinking water tray and the additive tray.

The third normal pressure flow path may be formed by an elastic button provided at the coupling plate, the elastic button being elastically deformed by an air pressure difference to selectively open and close a space between a lower part of the elastic cover and an upper surface of the coupling place and an inner space of the additive tray under the coupling plate.

The normal pressure flow path may further include a fourth normal pressure flow path configured to allow air in the inner space of the additive tray to move into the additive capsule therethrough.

The fourth normal pressure flow path may be formed by a flow path groove formed from an outer end of the protruding curved surface of the expansion plate to a central part of the expansion plate to form a flow path configured to allow air to move in a tight contact surface of the expansion plate therethrough and a cut surface formed by cutting an outer circumferential surface of a circular suction pipe, the cut surface being formed downward from an end of the flow path groove by a predetermined length to form a space in a surface through which the suction pipe extends.

### Advantageous Effects

A pumping tumbler for preparing beverages according to the present invention provides the following effects.

First, the shielding state of a rotating lid portion is adjusted depending on whether the mode is a use mode and a storage mode by a user horizontally rotating an opening and closing structure of the rotating lid portion in the state in which the rotating lid portion is coupled to a tray, whereby it is possible to prevent the rotating lid portion from being opened by unintentional external force or the like when carrying the pumping tumbler, and therefore it is possible to prevent a hygienic problem caused by leakage of contents.

Second, an additive tray configured to store a liquid additive is detachably coupled to a drinking water tray configured to store drinking water, whereby it is possible to easily store the liquid additive, and a certain amount of additive is added to the tumbler without the need to separately store and withdraw the additive, whereby it is possible to facilitate the preparation of a beverage using the additive.

Third, unlike a conventional tumbler in which it is difficult to clean the interior of a pumping unit due to the difficulty of dismantling the pumping unit, the interior of the pumping unit is easily cleaned such that a movement path for the additive can be cleaned, whereby hygiene is improved.

Fourth, components of a cover unit, including the pumping unit, are disassembled and reassembled through a simple operation, whereby it is possible to easily clean and maintain the same.

Fifth, a normal pressure flow path is formed to prevent degradation in function of the pumping unit due to negative pressure in an additive storage space, which enables the amount of additive discharged to be kept constant, whereby it is possible to maintain the uniformity and unity of beverage preparation.

Sixth, when the user drinks the drinking water, an air hole is opened to ensure that the pressure in a drinking water storage space is kept equal to atmospheric pressure, whereby it is possible to prevent uneven discharge of the drinking water and to enable the user to stably consume the drinking water.

Seventh, when pumping the additive, a drinking hole is opened to prevent an increase in pressure in the drinking water storage space caused by pumping of the additive, whereby it is possible to prevent scattering of drinking water droplets through the air hole, which is a micro-hole.

### DESCRIPTION OF DRAWINGS

FIG. 1 is an illustrative view showing the overall configuration of a pumping tumbler according to an embodiment of the present invention.

FIG. 2 is an exploded perspective view showing the detailed configuration of a cover unit according to an embodiment of the present invention.

FIG. 3 is an illustrative view showing a mode of use of the pumping tumbler according to the embodiment of the present invention.

FIG. 4 is a plan view showing the configuration of a closure portion according to an embodiment of the present invention.

FIG. 5 is a sectional view showing the internal configuration of the pumping tumbler according to the embodiment of the present invention.

FIG. 6 is an internal configuration view showing the main configuration of a pumping portion constituting the pumping tumbler according to the embodiment of the present invention.

FIG. 7 is an exploded sectional view showing the detailed configuration of a suction pipe module constituting the pumping tumbler according to the embodiment of the present invention.

FIG. 8 is an illustrative view showing the coupling structure of an additive tray and the suction pipe module according to a specific embodiment of the present invention.

FIG. 9 is an illustrative view showing the coupling structure of the additive tray, an additive capsule, and the suction pipe module according to a specific embodiment of the present invention.

FIG. 10 is an illustrative view showing the coupling structure of the additive tray and the additive capsule according to the embodiment of the present invention.

FIG. 11 is an illustrative view showing an embodiment in which an additive tray lid portion is provided at the additive tray according to the embodiment of the present invention.

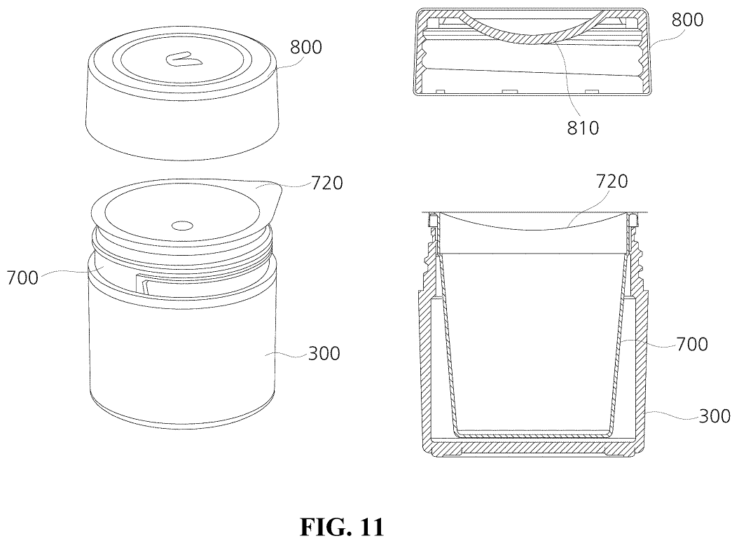

FIGS. 12 and 13 are illustrative views showing an example of a normal pressure flow path of the additive tray according to the embodiment of the present invention.

FIG. 13 is an illustrative view showing an example of a normal pressure flow path of the additive tray according to the embodiment of the present invention.

FIG. 14 is an illustrative view showing another example of the normal pressure flow path of the additive tray according to the embodiment of the present invention.

FIG. 15 is an illustrative view showing a flow path formation position in the other example of the normal pressure flow path of the additive tray according to the embodiment of the present invention.

FIG. 16 is an illustrative view showing an embodiment of the suction pipe module configured to form the normal pressure flow path of the present invention shown in FIGS. 12 and 14.

FIG. 17 is an illustrative view showing a further example of the normal pressure flow path of the additive tray according to the embodiment of the present invention.

FIG. 18 is an illustrative view showing another embodiment of the suction pipe module configured to form the normal pressure flow path of the present invention shown in FIG. 17.

### BEST MODE

A pumping tumbler for preparing beverages according to the present invention to accomplish the above objects includes a drinking water tray configured such that an upper part is open, a lower end is shielded, and a drinking water storage space configured to store drinking water or a beverage is formed therein, a cover unit detachably coupled to the upper part of the drinking water tray, the cover unit being configured to shield the open upper part of the drinking water tray, the cover unit being provided with a drinking hole through which a user can drink the drinking water or the beverage in the drinking water storage space, an additive tray detachably coupled to the lower end of the drinking water tray, the additive tray having formed therein an additive storage space configured to store an additive, and a pumping unit installed in the drinking water tray and the cover unit, the pumping unit being configured to pump the additive in the additive tray through a flow path formed through a bottom surface of the drinking water tray and to supply the additive to drinking water storage space, wherein the cover unit may include a closure portion detachably coupled to the drinking water tray, the drinking hole being formed through an upper surface of the closure portion, the pumping unit being installed through an upper surface of the closer portion so as to be spaced apart from the drinking hole, a rotating lid portion rotatably coupled to an upper part of the closure portion, the rotating lid portion being configured to rotate about a rotating shaft formed therein so as to extend in a downward direction, the rotating lid portion having an opening through which the closure portion is exposed, the drinking hole and an upper part of the pumping unit being exposed through the opening upon rotation, and a shielding support portion located downwardly of the closure portion, the shielding support portion being moved upward and downward in an axial direction of the rotating lid portion by rotation of the rotating lid portion, the shielding support portion being configured to open and close the drinking hole upon rotation of the rotating lid portion.

### MODE FOR INVENTION

Hereinafter, a preferred embodiment of the present invention will be described in detail with reference to the accompanying drawings.

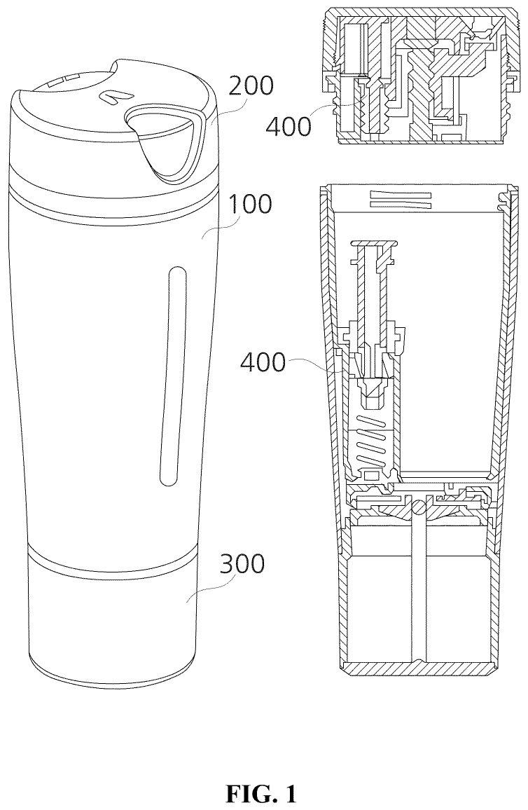

First, a pumping tumbler for preparing beverages according to an embodiment of the present invention, which is configured to mix an additive into drinking water or a beverage for consumption, may include a drinking water tray 100, a cover unit 200 and an additive tray 300 coupled to an upper part and a lower part of the drinking water tray 100, respectively, and a pumping unit 400 coupled to the drinking water tray 100 and the cover unit 200, as shown in FIG. 1.

The drinking water tray 100, which is a part constituting a cylindrical body of the tumbler, has formed therein a drinking water storage space configured to store drinking water or a beverage.

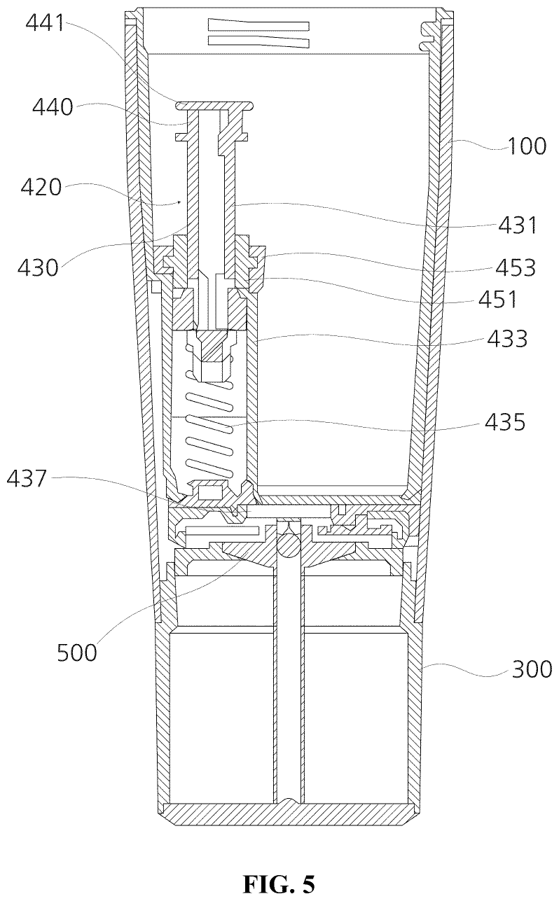

In the drinking water tray 100, the upper part is open and a lower end is shielded such that the drinking water storage space is formed therein to store drinking water or a beverage, and a through-hole 437 (see FIG. 5) configured to communicate with the pumping unit 400 is formed in the bottom of the lower end.

The cover unit 200 is detachably coupled to the upper part of the drinking water tray 100 to shield the open upper part of the drinking water tray 100, and a drinking hole 211 through which a user can drink the drinking water or the beverage in the drinking water storage space is formed in the cover unit.

Specifically, the cover unit 200 may include a closure portion 210, a rotating lid portion 220, and a shielding support portion 230.

The closure portion 210 is detachably coupled to the drinking water tray 100, the drinking hole 211 is formed through an upper surface of the closure portion such that the user can drink the stored beverage, and an upper end of the pumping unit 400 is installed through the upper surface of the closer portion on the side opposite the drinking hole 211.

In the figures, the closure portion 210 is shown as being detachably coupled to the drinking water tray 100 by screw engagement, which, however, is merely an embodiment, and various coupling methods, such as snap coupling or button coupling, may be used as long as it is possible to detachably couple the closure portion and the drinking water tray to each other while maintaining airtightness.

The rotating lid portion 220 is rotatably coupled to an upper part of the closure portion 210 and is configured to rotate about a rotating shaft 223 formed at an inner central portion of a lower end thereof when external force (user manipulation) is generated.

The rotating lid portion 220 is configured such that an opening 221 is formed to expose an upper part of the closure portion 210 and such that the drinking hole 211 and the pumping unit 400 are exposed through the opening 2211 when rotated.

In the figures, the rotating lid portion 220 is in the form of a cup open at a lower part thereof, and is rotatably coupled to the closure portion 210 in the state in which an inner surface of the lower part of the rotating lid portion and an upper surface of the closure portion 210 is in contact with each other.

Meanwhile, the cover unit 200 may be operated in a storage mode or a use mode depending on the relative rotational positions of the closure portion 210 and the rotating lid portion 220.

First, the storage mode indicates the state in which the drinking hole 211 and the pumping unit 400 are shielded to prevent the user from consuming the drinking water or the beverage and to prevent the operation of the pumping unit 400 and in which the drinking hole 211 is shielded by the shielding support portion 230.

In the use mode, the drinking hole 211 is opened by the opening 641 to allow the user to consume the drinking water or the beverage through the drinking hole 211, and at the same time, the pumping unit 400 is opened to allow the user to operate the pumping unit 400.

If the drinking hole 211 is opened when the pumping unit 400 is operated, the increased pressure in the drinking water tray 100 by pumping is released through the drinking hole 211.

That is, when the pumping unit 400 is operated, an additive stored in the additive tray 300 is introduced into the drinking water tray 100, thereby increasing the pressure in the drinking water tray 100.

At this time, the increased pressure is released through an air hole 213, which is a micro-hole, a description of which will follow, while making it difficult for the user to pump, and drinking water droplets are scattered together with the discharged air, causing drinking water spray to leak around the tumbler.

Accordingly, in the present invention, the drinking hole 211 is opened when the pumping unit 400 is operated such that air can flow through the drinking hole 211, which is a relatively large hole, whereby the pressure in the drinking water tray 100 may be maintained at a normal pressure.

Meanwhile, the mode of the cover unit 200 is switched between the storage mode and the use mode by rotation of the rotating lid portion 220.

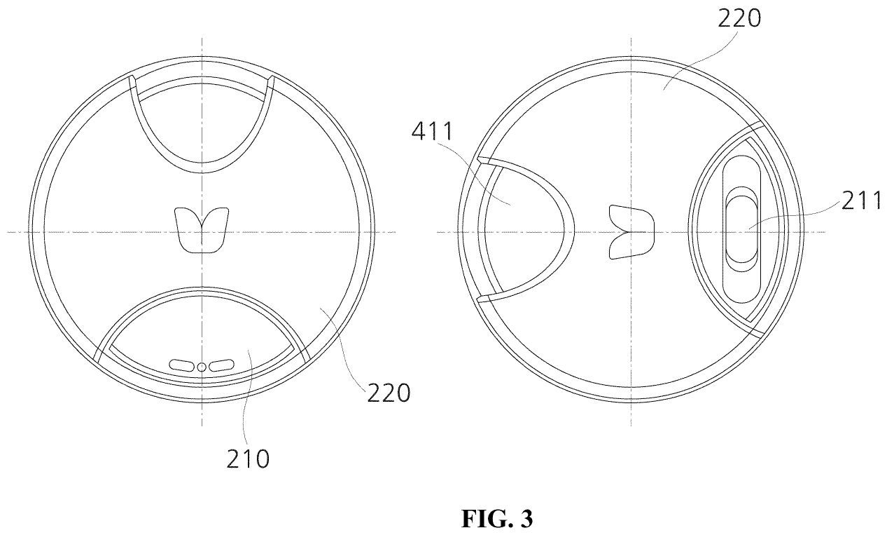

In the embodiment shown in FIG. 3, an example in which the mode of the cover unit 200 is switched from the use mode to the storage mode when the cover unit 200 is rotated 180 degrees is shown, but each of the modes may be variously configured at the relative rotational positions of the closure portion 210 and the rotating lid portion 220.

Meanwhile, the shielding support portion 230 is located downwardly of the closure portion 210, is configured to be moved upward and downward in an axial direction of the rotating lid portion 220 by rotation of the rotating lid portion 220 to serve to open and close the drinking hole 211 upon rotation of the rotating lid portion 220.

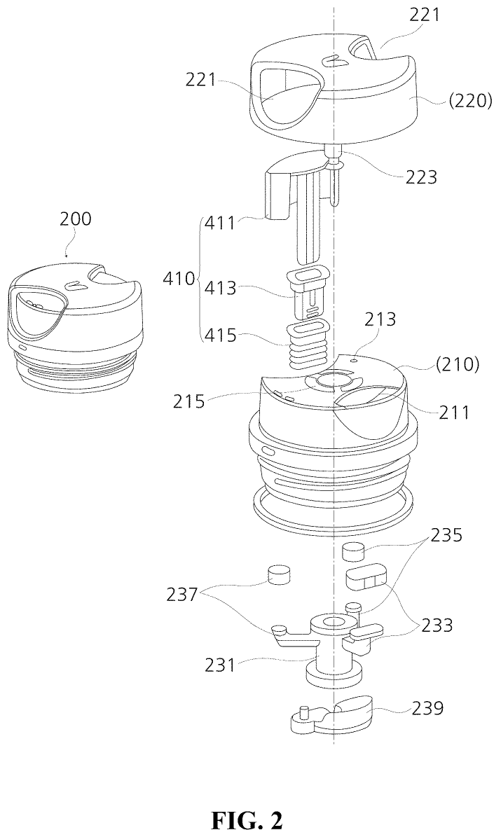

Referring to FIG. 2, the shielding support portion 230 may include a support body 231, a shielding portion 233, an air shielding portion 235, a balance support portion 237, and a lock cover 239.

First, the rotating shaft 223 is fixedly coupled to the rotating lid portion 220, and the support body 231 is axially coupled to the rotating shaft 223 so as to be moved upward and downward by rotation of the rotating lid portion 220.

To this end, the rotating shaft 223 has a screw portion formed along an outer circumferential surface thereof, and a cam screw (not shown) configured to engage with the screw portion is formed at an inner circumferential surface of the support body 231, whereby the support body 231 is moved upward and downward by rotation of the rotating shaft 223.

Meanwhile, in the storage mode of the present invention, the drinking hole and the air hole must be maintained in a shielded state, and in the use mode, the drinking hole and the air hole must be maintained in an open state.

To this end, the shielding portion 233 is configured such that one end is coupled to an outer surface of the support body 231 and the other end formed so as to extend from the one end opens and closes the drinking hole 211.

The air shielding portion 235 is coupled to the outer surface of the support body 231 so as to protrude therefrom, and extends so as to open and close the air hole 213 formed in the closure portion 210 by rotation of the rotating shaft 223.

The balance support portion 237 is coupled to the outer surface of the support body 231 between the shielding portion 233 and the air shielding portion 235 so as to protrude therefrom such that the balance support portion is moved upward and downward around the rotating shaft 223, whereby no eccentricity is generated and the shielding portion 233 and the air shielding portion 235 may stably shield the drinking hole 211 and air hole 213.

In this case, each of the shielding portion 233, the air shielding portion 235, and the balance support portion 237 may be provided at an end thereof with a cover made of an elastic material in order to improve the shielding effect when in tight contact.

Meanwhile, the closure portion 210 may be provided with a guide slit (not shown) configured to restrict rotation of the shielding support portion 230 such that the shielding support portion 230 can only be moved upward and downward without being rotated when the rotating lid portion 220 is rotated.

The guide slit is cylindrical in shape with an open lower part and a vertical slit, the shielding portion 233, the air shielding portion 235, and the balance support portion 237 are inserted into the guide slit, and the guide slit guides the shielding support portion 230 so as to be moved upward and downward along the slit while restricting the rotation thereof.

Meanwhile, the cover unit 200 may include a guide recess 215 configured to guide the relative rotation positions of the closure portion 210 and the rotating lid portion 220 so as to be located at set positions in the use mode and the storage mode and an anti-rotation stopper protrusion (not shown) configured to prevent excessive rotation of the rotating lid portion 220.

The guide recess 215 is formed in an upper surface of the closure portion 210, and is formed in an arc shape corresponding to the radius of rotation of the rotating lid portion 220 in each of the use mode and the storage mode.

The stopper protrusion may be formed so as to protrude downwardly of the rotating lid portion 220 and to be fitted into the guide recess 642, and may be formed so as to be caught by an inner surface of the guide recess 642 upon rotation, thereby limiting the rotation angle of the rotating lid portion 220.

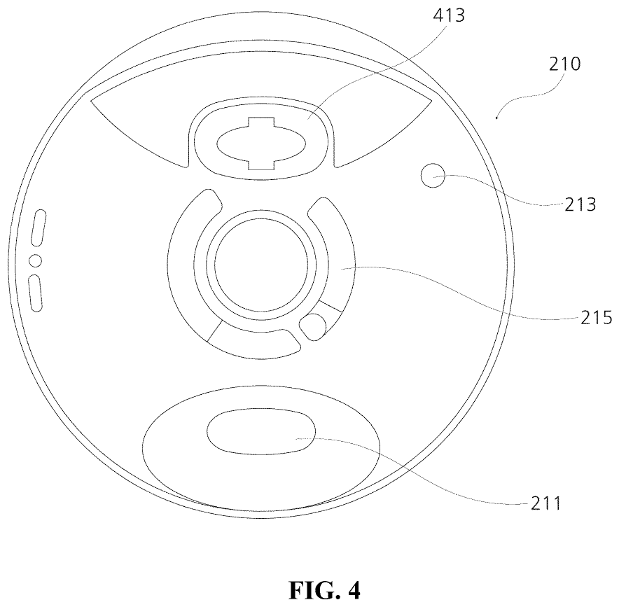

As shown in FIG. 4, the guide recess 215 is formed in a semicircular shape such that the rotation angle of the rotating lid portion 220 is 180 degrees so as to correspond to the rotation angle of the rotating lid portion 220 having a rotation angle of 180 degrees depending on whether the mode is the use mode or the storage mode. However, this is merely an embodiment, and the length of the guide recess may be set so as to correspond to the set rotation angle of the rotating lid portion 220.

Meanwhile, although not shown, it is possible to include a configuration in which the stopper protrusion can be seated in the guide recess 215 such that the user can intuitively detect the use mode and storage mode positions when the user rotates the rotating lid portion 630 in each mode.

In an embodiment of this configuration, the guide recess 215 may be configured such that the stopper protrusion is seated at each of the mode positions by forming the width of the guide recess so as to be greater than the width of other parts thereof for each of the mode positions.

Alternatively, in another embodiment, the depth of the guide recess 215 may be formed so as to be greater than the depth of other parts such that the stopper protrusion can be seated at each mode position, and various other embodiments are also possible.

As described above, the guide recess 215 and the stopper protrusion prevent excessive rotation of the rotating lid portion 220, thereby preventing breakage of the shielding support portion 233, preventing unintentional dismantling of the cover unit 200, and guiding the rotating lid portion 220 so as to stably turn in an operating zone.

Meanwhile, at least one of a side surface of the stopper protrusion and an inner surface of the guide recess 215 facing each other in the use mode may be formed as an inclined surface such that the external force of disengagement of the stopper protrusion from the guide recess 215 is reduced.

The inclined surface enables the stopper protrusion to move beyond the guide recess 215 when a certain external force of disengagement is applied.

That is, when the rotating lid portion 220 is moved to the use mode position, the shielding support portion 230 is moved downward, and when the rotating lid portion 220 is further moved in that direction, the shielding support portion 230 is further moved downward, provided that the movement of the support body 231 is not restricted by the lock cover 239, a description of which will follow.

Subsequently, when the rotating lid portion 220 is further rotated in the same direction, the shielding support portion 230 is disengaged from the rotating shaft 223, and the shielding support portion 230, the rotating lid portion 220, and the closure portion 210 are separated from each other.

Hereinafter, the configuration of a pumping unit of the present invention configured to pump an additive from the additive tray 300 and to provide the additive to the drinking water tray 100 will be described in detail.

The pumping unit 400 is installed in the drinking water tray 100 and the cover unit 200, and serves to pump an additive from the additive tray 300 and to supply the additive to an inner space of the drinking water tray 100.

The pumping unit 400 is configured to move the additive in fixed quantities by pumping of the user such that the amount of additive added can be adjusted according to the number of pumping times, and the pumping unit 400 may be installed in a longitudinal direction of the cover unit 200 and the drinking water tray 100, and may be installed at a position adjacent to an inner surface of the drinking water tray 100, as shown in FIGS. 2, 5, and 6.

Specifically, the pumping unit 400 may include a pumping button portion 410 and a pumping portion 420.

The pumping button portion 410 may be installed on the cover unit 200 so as to perform sliding reciprocating movement, and may be configured to be moved by pressing of the user.

The pumping button portion 410 may include a stem portion 411, a guide bushing 413, and an airtightness means 415.

The stem portion 411 is slidably installed in an insertion hole of the drinking water tray 100, wherein an upper part of the stem portion is exposed to the outside of the drinking water tray 100 so as to be pressed by the user, and a lower part of the stem portion transmits external force to the pumping portion 420.

The guide bushing 413, which is formed in the shape of a pipe, guides the stem portion 411 inserted thereinto so as to perform reciprocating movement, and is inserted into an upper part of the airtightness means 415. The guide bushing 413 may be configured such that a side surface of a lower end of a flange portion formed at an upper end thereof is in contact with an upper surface of the insertion hole so as to be fixed and supported in the insertion hole.

The guide bushing 413 may provide the effect of fixing an upper end of the airtightness means 415 to an inner circumferential surface of the insertion hole through the flange portion and reducing the friction force with the airtightness means 415 during upward and downward movement of the stem portion 411, thereby preventing damage to the airtightness means 415.

In this case, the pumping button portion 410 and the pumping portion 420 are located outside and inside the drinking water storage space by the airtightness means 415, which is made of an elastically deformable soft membrane.

The airtightness means 415 is formed in the shape of a cylindrical pipe having an open upper part and a closed lower part, the pumping button portion 410 is inserted into the airtightness means, a lower surface of the pumping button portion 410 is in contact with a bottom surface of the airtightness means, and a lower end surface of the airtightness means is in contact with the pumping portion 420.

The airtightness means 415 may be configured as a bellows having a plurality of corrugations formed on the outer circumferential surface in a circumferential direction so as to expand and contract in an upward-downward direction.

Consequently, transmission of physical force is possible while the outflow of the drinking water from the drinking water storage space to the pumping button portion 410 side is prevented.

Meanwhile, the pumping portion 420 is located in the drinking water storage space of the drinking water tray 100, and is moved upward and downward by the reciprocating movement of the pumping button portion 410, is connected to the drinking water storage space and an additive storage space so as to communicate therewith, and serves to suction the additive and to discharge the additive to the drinking water storage space by upward and downward movement.

To this end, the pumping portion 420 may include a piston portion 430 and a discharge pipe 440.

The piston portion 430 is located in the drinking water storage space, is in communication with the additive tray 300, and serves to suction an additive from the additive tray 300 and to discharge the suctioned additive to the discharge pipe 440 by reciprocating movement of the pumping button portion 410.

The piston portion 430 may include a piston rod 431, a piston housing 433, and an elastic member 435.

The piston rod 431 is interlocked with the pumping button portion 410, is moved upward and downward by reciprocating movement of the pumping button portion 410, is inserted into an inner space of the piston housing 433, and has formed therein a flow path configured to allow the additive in the piston housing 433 to move therethrough when pumped.

The piston rod 831 is installed in the inner space of the piston housing 433 so as to be moved upward and downward, a through-hole is formed in a lower end of the piston rod so as to communicate with the additive tray 300, and the piston rod is coupled to an upper part of the piston rod.

Accordingly, the additive in the additive tray 300 is introduced into the inner space of the piston housing 433 by the change in internal pressure due to upward and downward movement of the piston rod 431.

The discharge pipe 440 is a hollow pipe extending from an end of the piston portion 430 in a “U” shape, and discharges the pumped additive to the drinking water storage space.

In addition, an upper end (a “U”-shaped curved part) of the discharge pipe 440 is interlocked with the pumping button portion 410, and is moved upward and downward by reciprocating movement of the pumping button portion 410 to press the piston portion 430.

Meanwhile, an additive is introduced into and moved in the pumping portion 420, and after a certain period of use or when the additive is changed, it is necessary to clean the pumping portion.

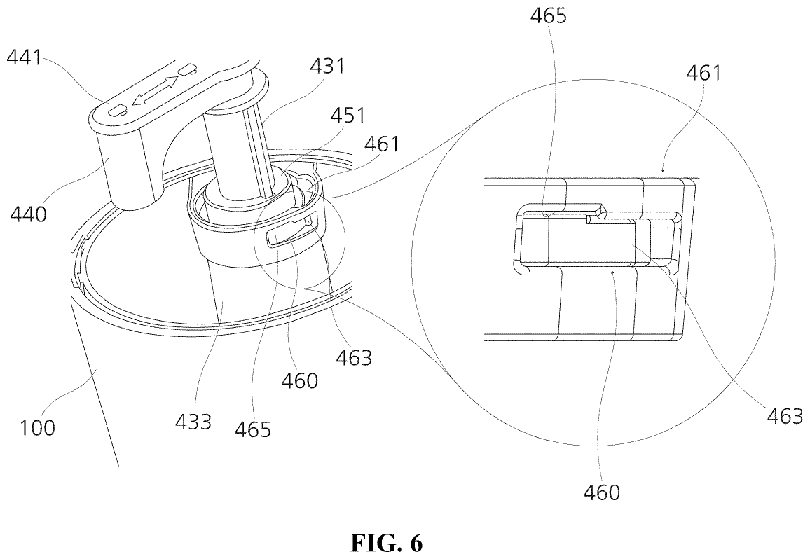

To this end, as shown in FIG. 6, an upper end surface (a “U”-shaped curved surface) of the discharge pipe 440 is provided with an openable closure plate 441, and the closure plate 441 is opened when the pumping portion 420 is washed, which facilitates washing of the piston portion 430 and the discharge pipe 440.

In addition, it is preferable to separate the piston rod 431 and the elastic member 435 from the piston housing 433 at the time of cleaning, and to this end, the piston rod 431 is detachably coupled to the piston housing 433.

Specifically, a fastening ring 451 coupled to the piston rod 431 so as to be movable upward and downward therealong is coupled to the piston rod 431, and a fastening recess 460 is formed in an inner circumferential surface of an upper end of the piston housing 433.

The piston rod 431 and the piston housing 433 are coupled to each other by insertion of a fastening protrusion 453 protruding from the side of the fastening ring 451 into the fastening recess 460 formed in the piston housing 433.

In this case, as shown in FIG. 6, the fastening recess 460 includes an upper incision portion 461 formed so as to have a size corresponding to the width of the fastening protrusion such that the fastening protrusion 453 can be inserted from the upper outside, a horizontal slit 463 extending from a lower end of the upper incision portion 461 in a horizontal direction, the horizontal slit being configured to allow the fastening protrusion 453 inserted into the upper incision portion 461 to be moved by rotation, and a vertical seating portion 465 extending upwardly of an end of the horizontal slit 463 such that the fastening protrusion 453 moved along the horizontal slit 463 is moved upward and seated thereon by the elastic force of the elastic member 435, thereby limiting rotational movement.

When pumping is repeatedly performed in the state in which the piston rod 431 is fastened to the piston housing 433, the vertical seating portion 465 maintains the stability of coupling between the piston housing 433 and the piston rod 431.

Specifically, when the piston rod 431 is reciprocated by pumping, if the force applied to the discharge pipe 440 deviates from the center of the piston rod, eccentricity is generated, and such eccentricity applies rotational force to the fastening ring 451, which may cause separation between the piston housing 433 and the piston rod 431 that is not intended by the user.

However, in the state in which the fastening protrusion 453 is seated on the vertical seating portion 465, even if simple rotational force is applied to the fastening ring 451, the fastening ring 451 does not rotate, thereby preventing separation between the piston housing 433 and the piston rod 431.

Meanwhile, the elastic member 435 is located in the piston housing 433, is coupled to the piston rod 431, and serves to provide resilient force to enable the piston rod 431 to move upward after being pressed and moved downward.

Meanwhile, in the present invention, the through-hole 437 formed through the lower part of the piston housing 433 and the lower part of the drinking water tray 100 and the additive tray 300 are connected to each other via a suction pipe module 500.

Hereinafter, the construction of a suction pipe module of the present invention configured to allow the additive tray 300 and the drinking water tray 100 to communicate with each other will be described in detail.

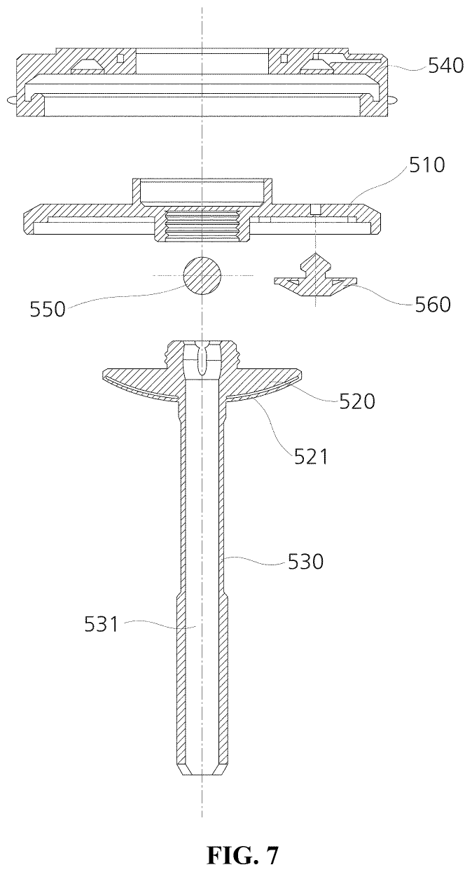

The suction pipe module 500 includes a coupling plate 510, an expansion plate 520, a suction pipe 530, and an elastic cover 540, as shown in FIG. 7.

The coupling plate 510 is formed in the shape of a disc so as to be coupled to a lower end of the drinking water tray 100, and the elastic cover 540 is coupled to an upper part of the outside of the coupling plate 510. The elastic cover 540 is made of an elastic material to improve adhesion with the lower end of the drinking water tray 100.

At this time, the elastic cover 540 and the coupling plate 510 are coupled to each other such that a predetermined space is formed therebetween.

The disc-shaped expansion plate 520 is detachably coupled to the center of a lower part of the coupling plate 510 by screw engagement.

In addition, the expansion plate 510 includes a circular suction pipe 530, wherein the suction pipe 530 extends through an additive capsule 700 or a shielding cover 600, a description of which will follow, and the expansion plate 520 is in tight contact with the extension region, thereby preventing leakage of the additive to the outside.

To this end, a lower end of the expansion plate 520 is provided with a protruding curved surface 521 whose lower surface protrudes from a central part as a curved surface such that adhesion is improved.

At this time, an introduction flow path configured to allow the coupling plate 510, the expansion plate 520, and the suction pipe 530 to communicate with each other therethrough and to allow the additive to move therethrough is formed in the coupling plate 510, the expansion plate 520, and the suction pipe 530, whereby the additive is introduced into the pumping portion 420 through the through-hole 437.

Meanwhile, the suction pipe 530 may be formed as a tapered circular pipe having a width gradually slightly decreasing in a downward direction.

In this case, when the suction pipe 530 extends through the additive capsule 700 or the shielding cover 600, the deeper the extension depth, the stronger the adhesive force of the extension region, whereby the risk of additive leakage may be reduced.

An opening and closing ball valve 550 configured to selectively open and close the additive introduction flow path may be provided inside a coupling portion of the expansion plate 520 coupled to the coupling plate 510.

The opening and closing ball valve 550 selectively opens and closes the introduction flow path in the suction pipe 530 according to upward and downward movement of the piston rod 431, wherein, when positive pressure is generated in the suction pipe 530, the opening and closing ball valve 550 moves upward to open the introduction flow path, and when negative pressure is generated in the suction pipe, the opening and closing ball valve 550 moves downward to close the introduction flow path.

Accordingly, the introduction flow path generates a flow only in the direction in which the additive is introduced into the drinking water tray 100.

Hereinafter, the construction of an additive tray of the present invention coupled to the lower part of the drinking water tray to provide additives to the drinking water tray will be described in detail.

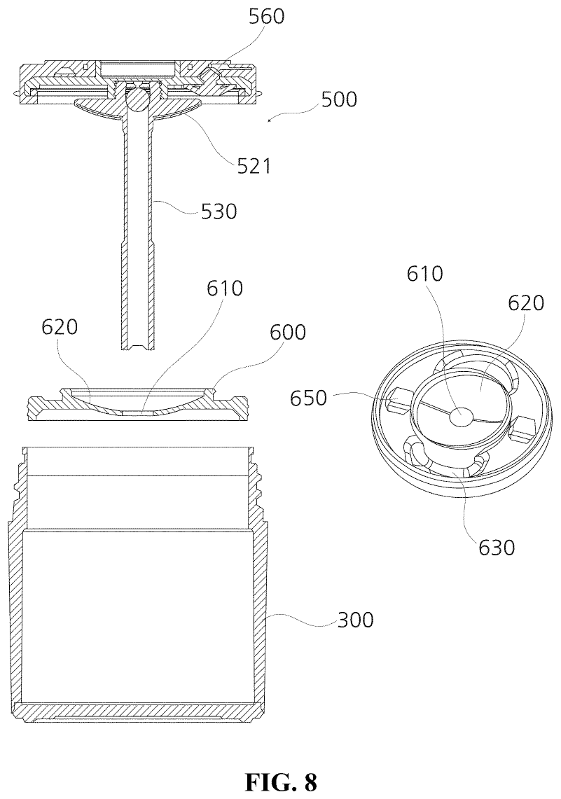

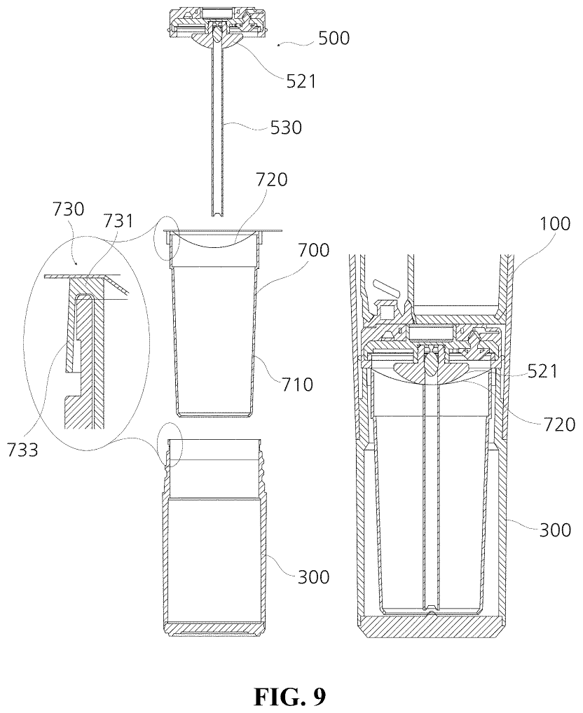

As shown in FIGS. 8 and 9, the additive tray 300 is open at an upper part thereof and shielded at a lower end thereof such that the additive storage space is formed therein, and is detachably coupled to the lower part of the drinking water tray 100 by screw engagement.

Meanwhile, in the present invention, the additive tray 300 may be configured as two embodiments according to the form of operation.

First, a first embodiment is an embodiment in which the additive tray 300 is directly filled with an additive.

In this case, there is a possibility that the additive may leak out of the additive tray 300, and therefore the present invention further includes a shielding cover 600.

The shielding cover 600 is configured to prevent leakage of the additive received in the additive tray 300, and is formed as a disc made of an elastic material so as to be press-fitted into an upper part of the additive tray 300.

In this case, the shielding cover 600 is provided in the center thereof with a central through-hole 610 configured to allow the suction pipe 530 to extend therethrough.

In addition, a central part of an upper surface of the shielding cover 600 is formed as a concave surface 620 corresponding in shape to the protruding curved surface 521 of the lower part of the expansion plate 520, which may improve adhesion with the expansion plate 520.

Meanwhile, the shielding cover 600 is preferably provided on the upper surface thereof with a gripping portion 630 configured to be gripped upon withdrawal of the shielding cover 600, thereby facilitating withdrawal of the shielding cover 600.

The shielding cover 600 may include a flow path incision portion 650 configured to allow air to move only in one direction from the top to the bottom.

As shown in FIG. 8, the flow path incision portion 650 may be formed as a pair of wings triggered downwardly of the shielding cover 600 so as to be in surface contact with each other. Accordingly, when negative pressure is generated under the shielding cover 600, air above the shielding cover 600 moves downward through the flow path incision portion 650, but the additive under the shielding cover 600 is prevented from moving upward through the flow path incision portion 650.

When the flow path incision portion 650 is formed, even if no cut surface is formed in the suction pipe 530, a flow path may be formed downward from above the shielding cover 600 to constitute a part F4 of a normal pressure flow path, a description of which will follow.

Next, in a second embodiment of the additive tray, an additive capsule 700, which is configured as a disposable container in which an additive is stored, is inserted into the additive tray 300.

In this case, the user does not introduce an undiluted additive solution into the additive tray 300 but inserts an additive capsule 700 containing an undiluted additive solution purchased from a manufacturer into the additive tray 300, whereby it is possible to easily use the additive.

In this case, the additive capsule 700 includes a container portion 710 abutting an inner surface and a bottom surface of the additive tray 300 and a lid film 720 configured to shield an upper surface of the container portion 710, as shown in FIG. 9.

The lid film 720, which is a part that is punched by pressing of the suction pipe 530, is a soft synthetic resin film, and is attached to an upper end of the container portion 710 by fusion.

In this case, a sidewall of the container portion 710 may include a protrusion formed as the result of an upper part of an outer circumferential surface thereof protruding outward, and a stepped portion configured to be seated on the inner surface of the additive tray 300 may be formed at the boundary of the protrusion.

The container portion 710 is provided at the edge of an upper end of the sidewall thereof with a seating portion 730 configured to be seated on the edge of the upper end of the additive tray 300, as shown in FIG. 9 in an enlarged state.

In this case, the seating portion 730 may include a horizontal plate 731 extending outward in parallel from the upper end of the sidewall by a distance corresponding to the thickness of the edge of the upper end of the additive tray 300 and a vertical plate 733 extending downward from an end of the horizontal plate 731 by a predetermined distance, whereby the additive capsule 700 may be coupled to the additive tray 300 such that the seating portion 730 wraps around the upper end of the additive tray 300.

Meanwhile, when the additive tray 300 and the drinking water tray 100 are separated from each other, the additive capsule 700 in the additive tray 300 generates friction force with the additive tray 300 and at the same time generates friction force with the suction pipe 530.

In this case, if the friction force between the additive capsule 700 and the suction pipe 530 is greater, the additive tray 300 and the drinking water tray 100 are separated from each other in the state in which the additive capsule 700 is attached to the suction pipe 530, thereby increasing the possibility that the additive capsule 700 falls to the floor or the additive leaks to the outside.

In order to prevent this, a catching jaw 750 and a catching protrusion 740 may be formed on the container portion 710 and the additive tray 300, respectively, in order to increase the force of coupling between the additive tray 300 and the additive capsule 700 in the present invention.

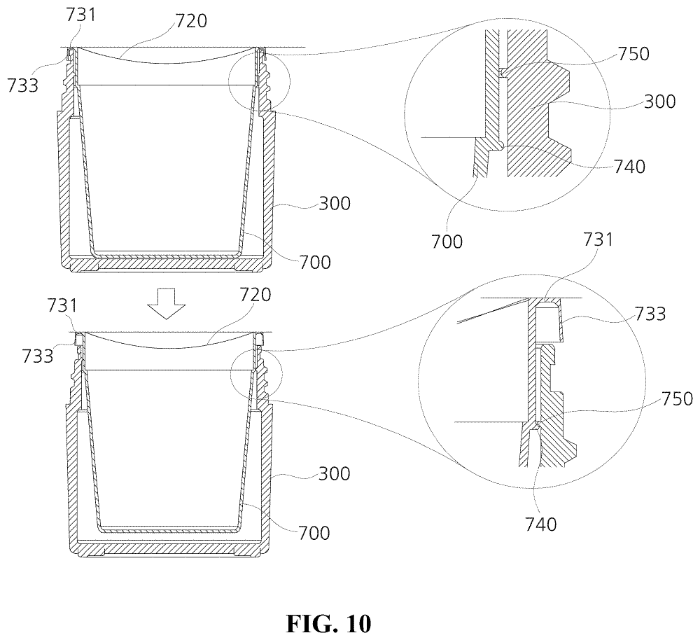

That is, as shown in FIG. 10, the catching jaw 750 and the catching protrusion 740 are formed respectively on an outer surface of the container portion 710 and an inner surface of the additive tray 300 at positions corresponding to each other when coupled to each other, whereby, when the additive tray 300 is separated from the drinking water tray 100, the catching protrusion 740 is supported by the catching jaw 750 such that the additive capsule 300 is stably located in the additive tray 300.

Meanwhile, when the catching jaw 750 is formed on the inner surface of the additive tray 300, the catching jaw may also serve to allow the outer circumferential surface of the shielding cover 600 inserted into the additive tray 300 to be seated thereon, thereby supporting the insertion position of the shielding cover 600.

When the additive tray 300 and the drinking water tray 100 are coupled to each other by screw engagement, the outside of the elastic cover is located between an upper end surface of the additive tray 300 and a lower surface of the outside of the drinking water tray 100.

Consequently, the outside of the elastic cover 540 made of the elastic material is pressed by the force of coupling between the additive tray 300 and the drinking water tray 100 due to screw engagement, whereby the sealing force of the inner space of the additive tray 300 is increased.

Meanwhile, regardless of the embodiment of the additive tray 300, the additive tray 300 may further include an additive tray lid portion 800 configured to shield the upper part of the additive tray 300 in order to secure stand-alone portability of the additive tray in the state in which the additive tray 300 is separated from the drinking water tray 100.

The additive tray lid portion 800, which is a lid of the additive tray 300, may be coupled to the additive tray 300 by screw engagement, and may be provided in the center of an inner surface thereof with a hemispherical downwardly protruding pressing protrusion surface 810, which is a curved surface, configured to shield a through-hole of an upper part of the additive capsule 700 or a through-hole of the shielding cover 600.

Accordingly, the additive tray 300 may be separated from the drinking water tray 100 so as to be safely carried and stored alone.

In the present invention, as the additive in the additive tray 300 is pumped through the pumping unit 400 and is supplied to the drinking water storage space, negative pressure is formed in the additive tray 300, whereby pumping of the additive is not smoothly performed, and as a result, the amount of the additive that is discharged in one pump is reduced, and the amount of the additive that is discharged becomes uneven, and therefore it becomes difficult to prepare a fixed amount of mixed beverage, and furthermore, when it is necessary to replace the additive tray 300, it may be difficult to open the additive storage space due to the internal pressure thereof.

Accordingly, it is preferable to form a normal pressure flow path configured to allow outside air to be introduced into the additive tray according to the present invention therethrough to maintain the pressure in the additive tray at normal pressure when negative pressure is generated in the additive tray.

Hereinafter, the structure of a normal pressure flow path configured to maintain normal pressure in the additive tray 300 of the present invention when the additive is pumped from the additive tray will be described in detail.

In the present invention, the normal pressure flow path is divided into four normal pressure flow paths, i.e. a first normal pressure flow path to a fourth normal pressure flow path, for convenience of description.

First, the first normal pressure flow path F1 refers to a flow path through which outside air can be introduced from the outside into the coupling space between the lower part of the drinking water tray and the additive tray.

The second normal pressure flow path F2 refers to a flow path which communicates with the first normal pressure flow path F1 and through which the introduced outside air is introduced into the space between the elastic cover and the coupling plate.

In addition, the third normal pressure flow path F3 refers to a flow path which communicates with the second normal pressure flow path and through which the introduced outside air moves into the inner space of the additive tray under the coupling plate.

Finally, the fourth normal pressure flow path F4 refers to a flow path which communicates with the third normal pressure flow path F3 and through which the air in the inner space of the additive tray moves into the additive capsule.

That is, in the present invention, the normal pressure flow path is constituted by a combination of the first normal pressure flow path and the fourth normal pressure flow path, and the normal pressure flow path of the present invention is mainly divided into three normal pressure flow paths according to the detailed configuration of implementation of each normal pressure flow path.

Hereinafter, each embodiment of the normal pressure flow path will be described in detail.

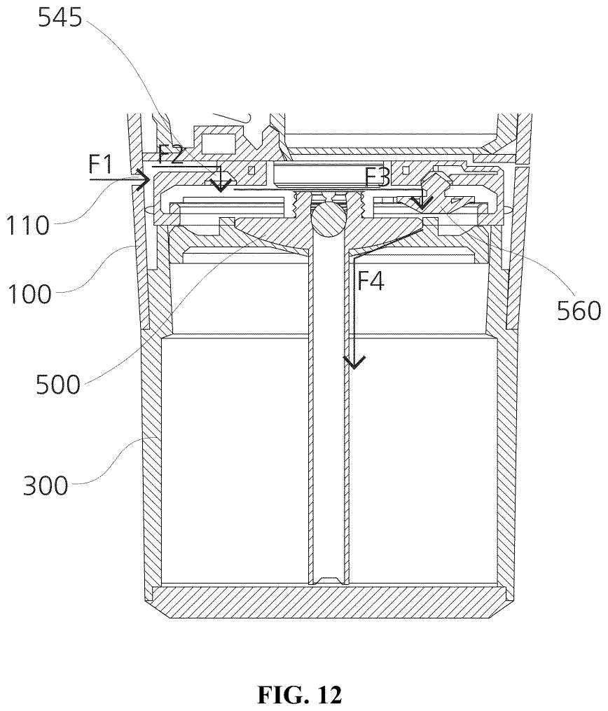

First, in a first embodiment of the normal pressure flow path, as shown in FIG. 12, outside air is introduced into the space between the elastic cover 540 and the drinking water tray 100 through an inlet hole 110 in the side of the drinking water tray 100 (F1), the introduced air moves between the elastic cover 540 and the coupling plate 510 through a vertical communication hole 545 of the elastic cover 540 (F2), the moved air moves downwardly of the coupling plate 510 through an elastic button 560 (F3), and the air moves downwardly of the shielding cover 600 or inwardly of the additive capsule 700 along a flow path groove 525 of the expansion plate 520 and a cut surface of the suction pipe 530 (F).

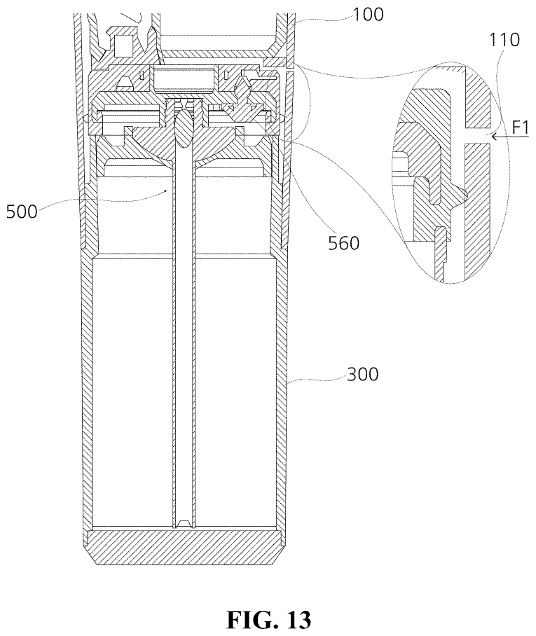

To this end, as shown in FIG. 13, an inlet hole 110 configured to introduce outside air is formed in the part of the side of the drinking water tray 100 located in the space between the elastic cover 540 and the lower end of the drinking water tray 100.

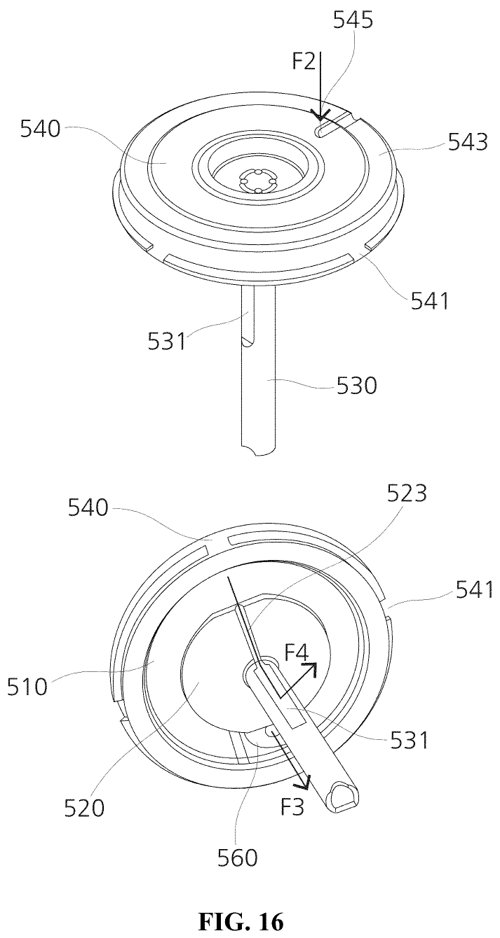

In addition, in order to form a space at the outside between the elastic cover 540 of the suction pipe module 500 and the lower end of the drinking water tray 100, a part of any one of the upper surface of the elastic cover 540 and the lower surface of the outside of the drinking water tray 100 is formed as a stepped surface or an inclined surface (see FIG. 16).

In addition, in order to form the second normal pressure flow path F2, the elastic cover 540 is provided with a vertical communication hole 545 configured to allow the space between the elastic cover 540 and the lower end of the drinking water tray 100 and the space between the lower part of the elastic cover 540 and the coupling plate 510 to communicate with each other therethrough (see FIG. 16).

Meanwhile, the coupling plate 510 is provided with an elastic button 560 in order to form the third normal pressure flow path F3, wherein the elastic button 560 is a kind of pressure valve that is elastically deformed by the air pressure difference between the upper part and the lower part of the coupling plate 510 so as to be selectively opened and closed.

In addition, in the present invention, a flow path groove 523 is formed in the coupling plate 510 and a cut surface 531 is formed on the upper end of the suction pipe 530 in order to form the fourth normal pressure flow path.

The flow path groove 523 is formed from an outer end of the protruding curved surface 521 of the expansion plate 520 to a central part of the expansion plate to form a flow path configured to allow air to move in the tight contact surface of the expansion plate 520 therethrough, and the cut surface 531 is formed by cutting the outer circumferential surface of the circular suction pipe 530 and is formed downward from an end of the flow path groove 523 by a predetermined length to form a space in the surface through which the suction pipe 530 extends.

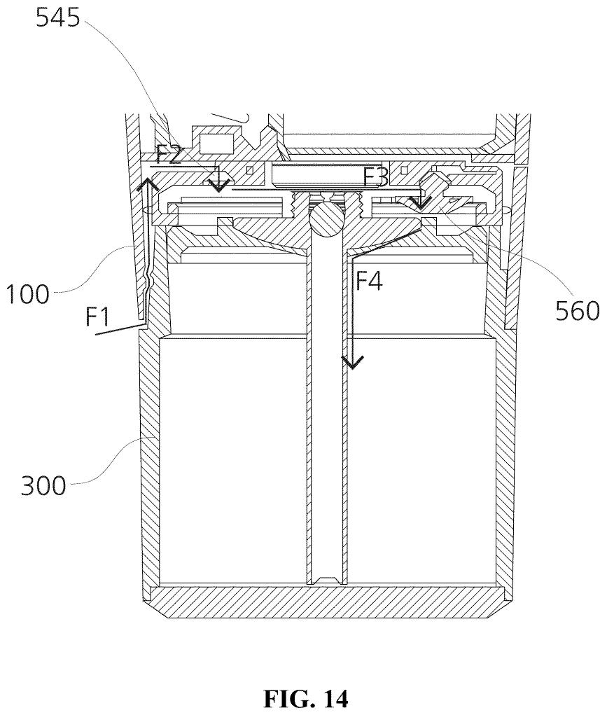

Next, in a second embodiment of the normal pressure flow path, as shown in FIG. 14, outside air is introduced through the coupling portion between the drinking water tray 100 and the additive tray 300, passes through a spacing recess 541 of the elastic cover 540, and is introduced into the space between the elastic cover 540 and the drinking water tray 100 (F1), the introduced air is moved between the elastic cover 540 and the coupling plate 510 through the vertical communication hole 545 of the elastic cover 540 (F2), the moved air is moved downwardly of the coupling plate 510 through the elastic button 560 (F3), and the air is moved downwardly of the shielding cover 600 or inwardly of the additive capsule 700 along the flow path groove 525 of the expansion plate 520 and the cut surface of the suction pipe 530 (F4).

To this end, a space is formed between the coupling surfaces and the coupling ends of the drinking water tray 100 and the additive tray 300, and outside air is introduced through the space.

At this time, the introduced air must be introduced into the space between the elastic cover 540 and the drinking water tray 100 through the inner surface of the lower part of the drinking water tray and the outer surface of the elastic cover (F1), and to this end, as shown in FIG. 16, a part of the interface between the inner surface of the lower part of the drinking water tray and the outer surface of the elastic cover is provided with a spacing recess 541 through which the introduced outside air can move.

Since the second normal pressure flow path F2, the third normal pressure flow path F3, and the fourth normal pressure flow path F4 are the same as in the first embodiment of the normal pressure flow path described above, a detailed description thereof will be omitted.

Meanwhile, with regard to the formation of the space between the coupling surfaces and the coupling ends of the drinking water tray 100 and the additive tray 300, the space formed between the coupling ends of the drinking water tray 100 and the additive tray 300 may be formed by a step between the coupling ends of the drinking water tray 100 and the additive tray 300.

That is, the space is formed by increasing the length of the coupling portion of the additive tray 300 so as to be greater than the length of the coupling portion of the drinking water tray 100.

In this case, since the elastic cover 540 is provided at the coupling surface of the upper end of the additive tray 300, the coupling step is formed by the sum of the screw engagement height of the outside of the upper part of the additive tray 300 and the height of the outer surface of the elastic cover 540 minus the screw engagement height of the inside of the lower part of the drinking water tray 100.

In this case, when the additive tray 300 and the drinking water tray 100 are coupled to each other with relatively large force, the coupling step is reduced.

Meanwhile, the coupling step must be configured such that air can be introduced while maintaining stable coupling force between the additive tray 300 and the drinking water tray 100, is also varied by screw engagement, and preferably has a size of approximately 1 to 10 mm.

The space formed between the coupling surfaces of the drinking water tray 100 and the additive tray 300 is formed by the gap between coupling threads of the drinking water tray 100 and the additive tray 300.

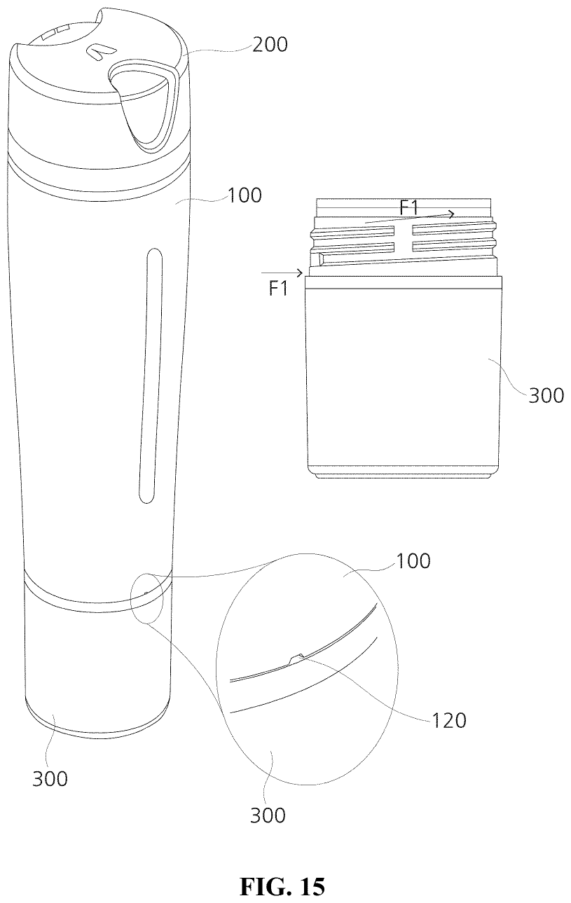

At this time, the gap between the coupling threads may be formed by the space between the threads, or an upward gap may be formed by removing a part of each of the threads, as shown in FIG. 15.

That is, as shown in FIG. 15, the space between the coupling ends of the drinking water tray 100 and the additive tray 300 may be formed by one or more introduction incision portions 120 formed by finely incising the coupling ends of the drinking water tray 100 and the additive tray 300.

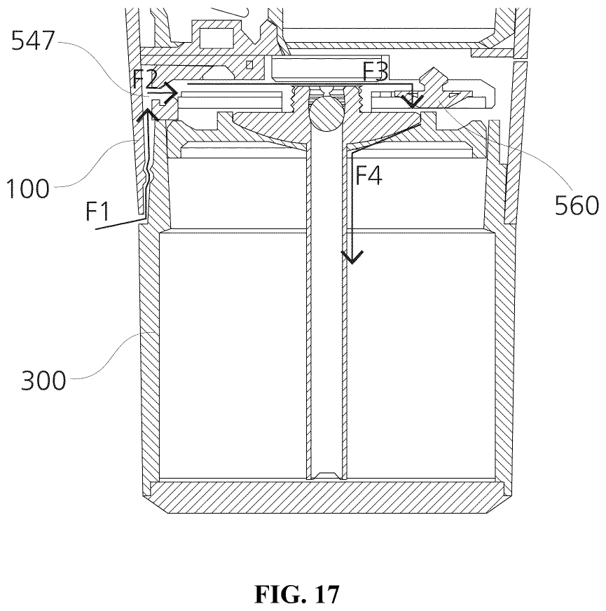

Finally, in a third embodiment of the normal pressure flow path, as shown in FIG. 17, outside air is introduced through the coupling portion between the drinking water tray 100 and the additive tray 300 and is introduced into the space between the side of the elastic cover 540 and the inside of the drinking water tray 100 (F1), the introduced air moves between the elastic cover 540 and the coupling plate 510 through the horizontal communication hole 545 of the elastic cover 540 (F2), the moved air moves downwardly of the coupling plate 510 through the elastic button 560 (F3), and the air is moved downwardly of the shielding cover 600 or inwardly of the additive capsule 700 along the flow path groove 525 of the expansion plate 520 and the cut surface of the suction pipe 530 (F).

Since the formation of the space between the coupling surfaces and the coupling ends of the drinking water tray 100 and the additive tray 300 is the same as in the second embodiment of the normal pressure flow path described above, a detailed description thereof will be omitted.

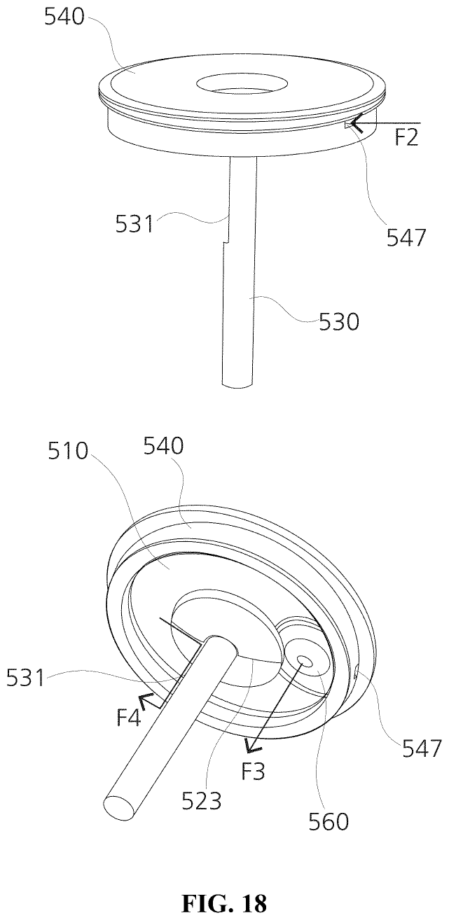

Meanwhile, the air introduced into the space between the side of the elastic cover 540 and the inside of the drinking water tray 100 moves between the elastic cover 540 and the coupling plate 510 through the horizontal communication hole 545 of the elastic cover 540 to form a second normal pressure flow path. To this end, as shown in FIG. 18, a horizontal communication hole 547 configured to allow the space between the lower part of the outer surface of the elastic cover 540 and the inner surface of the lower part of the drinking water tray 100 and the space between the lower part of the elastic cover 540 and the coupling plate 510 to communicate with each other therethrough is formed in the side of the elastic cover 540.

In addition, as shown in FIG. 18, the upper part of the side of the elastic cover 540 is in tight contact with the inner circumferential surface of the drinking water tray 100, the lower part of the side of the elastic cover is spaced apart from the inner circumferential surface of the drinking water tray 100 such that a space is formed therebetween, and the horizontal communication hole 547 is formed downwardly of the side of the elastic cover 540 in which the space is formed.

At this time, one or more wings may be formed on the upper part of the side of the elastic cover 540 so as to be in tight contact with the inner circumferential surface of the drinking water tray 100, or the entirety of the upper part of the side of the elastic cover 540 may be in tight contact with the inner circumferential surface of the drinking water tray 100.

Since the third normal pressure flow path F3 and the fourth normal pressure flow path are the same as in the first embodiment and the second embodiment of the normal pressure flow path described above, a detailed description thereof will be omitted.

In the present invention, the normal pressure flow path is formed as described above, which allows outside air to be introduced into the additive storage space during pumping to release the negative pressure (vacuum pressure) formed therein, thereby facilitating pumping, keeping the amount of additive discharged by pumping constant, and facilitating opening of the additive tray 300.

The present invention has been described with reference to the embodiments shown in the drawings, but the embodiments are merely illustrative, and a person having ordinary skill in the art will understand that various modifications and other equivalent embodiments can be derived therefrom. Accordingly, the true scope of technical protection of the present invention should be determined by the technical ideas of the appended claims.

### INDUSTRIAL APPLICABILITY

The present invention relates to a portable pumping tumbler for preparing beverages capable of facilitating the preparation of a beverage by receiving drinking water and an additive together and pumping the additive according to a user's need so as to be added to the drinking water, and according to the present invention, the shielding state of a rotating lid portion is adjusted depending on whether the mode is a use mode and a storage mode by the user horizontally rotating an opening and closing structure of the rotating lid portion in the state in which the rotating lid portion is coupled to a tray, whereby it is possible to prevent the rotating lid portion from being opened by unintentional external force when carrying the pumping tumbler, and therefore it is possible to prevent a hygienic problem caused by leakage of contents.

1. An additive capsule configured to be inserted into an additive tray of a pumping tumbler for preparing beverages, the pumping tumbler comprising:
a drinking water tray configured such that an upper part is open, a lower end is shielded, and a drinking water storage space configured to store drinking water or a beverage is formed therein;
a cover unit detachably coupled to the upper part of the drinking water tray, the cover unit being configured to shield the open upper part of the drinking water tray, the cover unit being provided with a drinking hole through which a user can drink the drinking water or the beverage in the drinking water storage space;
an additive tray detachably coupled to the lower end of the drinking water tray, the additive tray having formed therein an additive storage space configured to store an additive; and
a pumping unit installed in the drinking water tray and the cover unit, the pumping unit being configured to pump the additive in the additive tray through a flow path formed through a bottom surface of the drinking water tray and to supply the additive to drinking water storage space, wherein
the additive capsule is configured as a disposable container configured to store an additive,
the additive capsule comprises:
a container portion abutting an inner surface and a bottom surface of the additive tray; and
a lid film configured to shield an upper surface of the container portion, and
the lid film is punched by pressing of the suction pipe.

2. The additive capsule according to claim 1, wherein
a catching jaw and a catching protrusion are formed respectively on an outer surface of the container portion and an inner surface of the additive tray at positions corresponding to each other when coupled to each other, and
when the additive tray is separated from the drinking water tray, the additive capsule is located in the additive tray.

3. The additive capsule according to claim 2, wherein
a sidewall of the container portion comprises a protrusion formed as a result of an upper part of an outer circumferential surface thereof protruding outward, and
a stepped portion configured to be seated on the inner surface of the additive tray is formed at a boundary of the protrusion.

4. The additive capsule according to claim 3, wherein a seating portion configured to be seated on an edge of an upper end of the additive tray is formed at an edge of an upper end of the sidewall.

5. The additive capsule according to claim 4, wherein the seating portion comprises a horizontal plate extending outward in parallel from the upper end of the sidewall by a distance corresponding to a thickness of the edge of the upper end of the additive tray.

6. The additive capsule according to claim 5, wherein the seating portion further comprises a vertical plate extending downward from an end of the horizontal plate by a predetermined distance.
